(19) United States
(12) Patent Application Publication
(10) Pub. No.: US 2007/0118881 A1
(43) Pub. Date: May 24, 2007

(54) Application control at a policy server

(76) Inventors: Julian Mitchell, Maidenhead (GB); David Ress, Cary, NC (US)

Correspondence Address: BARNES & THORNBURG LLP, P.O. BOX 2786, CHICAGO, IL, 60690-2786, US

(21) Appl. No.: 11/283,428

(22) Filed: Nov. 18, 2005

(51) Int. Cl. H04L 9/32

(52) U.S. Cl. 726/4

(57) ABSTRACT

A packet-based communication system comprises first and second endpoints, an application manager and a policy server. When establishing a connection between the endpoints the application manager sends, to the policy server, application control related information about the required connection. The policy server then selects at least one application control parameter, such as a codec to be used by the endpoints, and returns this information to the application manager. The application control information can be carried between the application manager and policy server by an application control protocol, such as the Session Initiation Protocol (SIP), or by modified forms of policy control protocols such as the Common Open Policy Service (COPS), Diameter, SOAP/XML or Parlay.

### FIELD OF THE INVENTION

This invention relates to signalling within a packet-based communications system to establish a connection.

### BACKGROUND TO THE INVENTION

Communications networks are increasingly being used to deliver a range of multimedia communications traffic via packet-based delivery protocols.

It is generally preferred that packet-based networks use some form of admission control which controls access to the shared network and helps to maintain a particular quality of service (QoS) for the traffic that is permitted access to the network. Admission control can be performed by policy controllers in the network, with enforcement occurring at policy enforcement points (PEP). Admitted traffic can also be policed by the PEP, during the duration of a connection, to ensure that the parameters agreed at the beginning of the connection are adhered to.

FIG. 1 shows a communications system which is based around a packet-based network 30. Terminals 10, 20 are connected to network 30 via policy enforcement points, such as media gateways or routers, which police connections. When setting up a connection across a packet-based network, signalling 15 occurs between an endpoint 10 and an Application Manager 40. The Application Manager 40 determines capabilities of the endpoints 10, 20, such as the types of codec that each endpoint supports. The Application Manager 40 makes a selection of certain parameters (e.g. selecting what it determines is the best codec and hence bandwidth for the connection) and submits a connection request to the policy server 50. The policy server 50 determines whether a connection, with the requested parameters, can be supported and returns a reply to the Application Manager. If the connection cannot be supported, then the Application Manager 40 can either submit a further connection request or it can return an error message to the endpoint 10. If the connection cannot be supported then further requests can be submitted by the Application Manager, which can result in a high volume of signalling messages between the Application Manager and policy server.

The present invention seeks to provide an alternative architecture which is more efficient.

### SUMMARY OF THE INVENTION

A first aspect of the present invention provides a method of establishing a connection between first and second endpoints in a packet-based communication system which comprises an application manager and a policy server, the method comprising, at the application manager:

receiving information about the required connection;

sending, to the policy server, application control related information for the required connection;

receiving, from the policy server, at least one application control parameter selected by the policy server.

By sending application control information to the policy server, such as the list of codecs available at the endpoints, the policy server can use this information to decide certain application control parameters relating to the connection, such as selecting which codecs should be used by the endpoints. Making application control selections at the policy server, rather than at the application manager, can significantly reduce signalling between the application manager and the policy server compared to existing methods. This is because the policy server is better placed to make the selection.

The application control information can be carried between the application manager and policy server in various ways. The information can be carried by an application control protocol, such as the Session Initiation Protocol (SIP), or it can be carried by modified forms of policy control protocols such as the Common Open Policy Service (COPS), Diameter, SOAP/XML or Parlay. Conventionally, application control protocols are not used to interface with a policy server, and policy control protocols do not carry application control parameters such as a list of supported codecs.

Further aspects of the invention relate to a method performed by a policy server. Still further aspects of the invention relate to an application manager and a policy server which implement these methods.

The functionality described here can be implemented in software, hardware or a combination of these. Accordingly, further aspects of the invention provide a computer program product for implementing any combination of the steps of the methods according to the invention. It will be appreciated that the software can be installed on the host apparatus (e.g. the application manager or policy server) at any point during the life of the equipment. The software may be stored on an electronic memory device, hard disk, optical disk or other machine-readable storage medium. The software may be delivered as a computer program product on a machine-readable carrier or it may be downloaded directly to the host via a network connection.

### BRIEF DESCRIPTION OF THE DRAWINGS

Embodiments of the invention will be described with reference to the accompanying drawings in which:

FIG. 1 shows a generalised architecture of a packet-based communications system;

FIG. 2 shows an equivalent architecture to FIG. 1 for a PacketCable system;

FIG. 3 shows the network of FIG. 1 with the addition of media proxy control;

FIG. 4 shows an equivalent architecture to FIG. 1 for a 3G wireless system;

### DESCRIPTION OF PREFERRED EMBODIMENTS

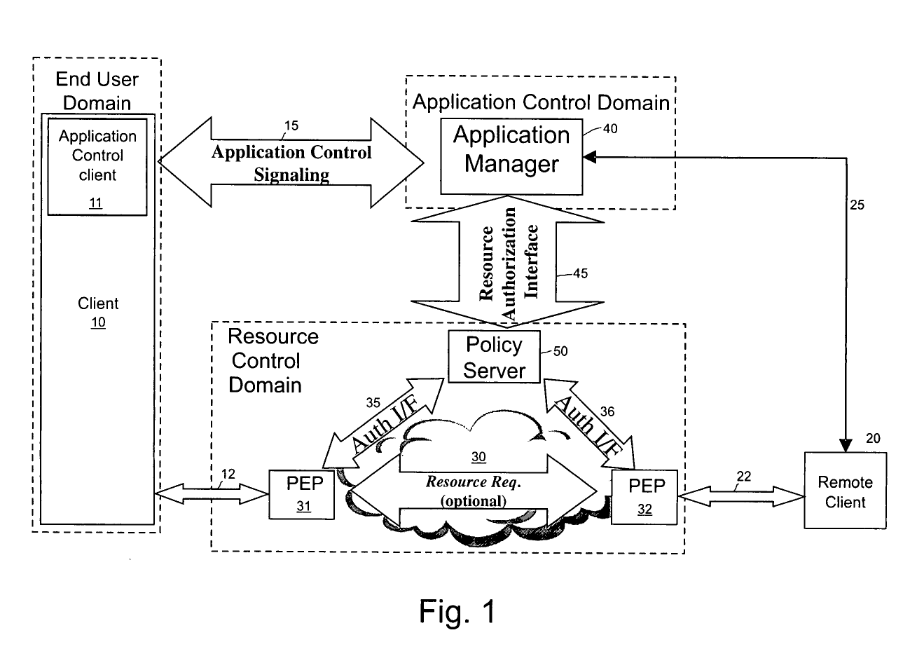

Referring again to FIG. 1, this shows a general overview of a system which includes a packet-based network 30. Although not shown, network 30 includes routers which are interconnected by communication links in a conventional manner. The network 30 can be implemented by wireline, wireless or a combination of both wireline and wireless technologies. Although shown as one overall network, network 30 can comprise a number of individual networks which are interconnected. Several specific architectures for PacketCable and 3G wireless networks are described later, and these share the same general features shown here.

Endpoints 10, 20 can be terminals which support a packet-based connection. Alternatively, endpoints 10, 20 can be Media Gateways which perform conversion between the circuit-switched domain, which is used to serve terminals (such as conventional telephone terminals) local to the gateway, and the packet-switched domain used across network 30.

An Application Manager 40 is a network entity which defines service control policies and co-ordinates subscriber-initiated requests for application sessions with access to the network resources that are required to meet those requests. The Application Manager 40 communicates 15, 25 with end points 10, 20 using a signalling protocol such as the Session Initiation Protocol (SIP).

The Application Manager 40 authenticates and authorizes client requests based on Service Control Domain policies. This ensures that clients making a request are entitled to use the requested services. For client requests that pass these checks, the Application Manager 40 determines the particular QoS parameters necessary to deliver the service to the client, based on its knowledge of the requested service. The Application Manager 40 communicates with a Policy Server 50 across an interface 45. The Application Manager 40 sends a request for the required resources to the appropriate Policy Server 50 via interface 45. The Policy Manager 50 may deny the request, based on network policies, or it may process (forward) the request to entities within network 30. This process can include communicating 35, 36 with Policy Enforcement Points (PEPs) 31, 32 that are responsible for admission control and enforcement. A connection between endpoints 10, 20 may require the policy server 50 to communicate with a larger number of PEPs, particularly if the connection spans several differently owned/operated networks. Policy decisions can be based on a number of factors, such as: parameters associated with the request and the status of available resources; the identity of the particular client and associated profile information; application parameters; security considerations.

Policy Enforcement Points (PEPs) 31, 32 within the network 30 act as gates, allowing certain traffic flows to pass. As part of a call establishment process, policy server 50 communicates with PEPs to ensure that sufficient resources are available to meet the request received from the Application Manager 40. If resources are available, then the Policy Server 50 returns an acknowledgement message to the Application Manager 40 across interface 45. A communication path is then established between the endpoints 10, 20 which includes path 12, between client 10 and PEP 31, a path across network 30, and a path 22 between PEP 32 and the remote client 20.

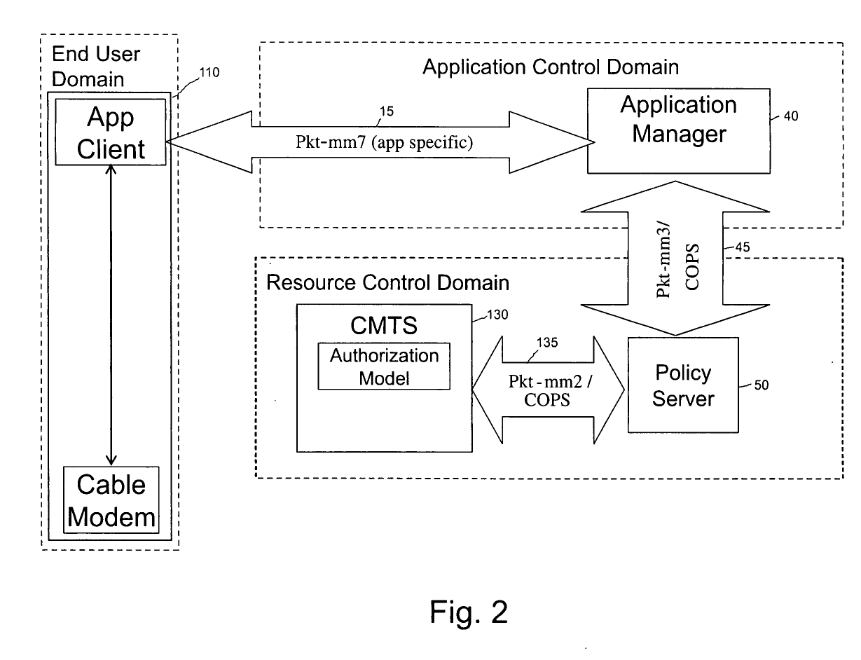

Various protocols have been proposed for use across interface 45 between the Application Manager 40 and Policy Sever 50. FIG. 2 shows a system according to the PacketCable Multimedia Specification (PKT-SP-MM-I01-030627). A cable modem 110 equates to the endpoint 10. The interface 15 between the cable modem 110 and the Application Manager 40 is called the ‘pkt-mm7’ interface and the interface 45 between the Application Manager 40 and Policy Server 50 is called the ‘pkt-mm-3’ interface. It has been recommended that the Common Open Policy Service (COPS) is used across the pkt-mm3 interface 45. The Common Open Policy Service (COPS) is defined in RFC 2748, to which the skilled reader is directed for further information. Policy Server 50 communicates with a Cable Modem Termination System (CMTS) 130 via a ‘pkt-mm2’ interface 135 using COPS. CMTS 130 authorizes resource requests.

Operation of the network using COPS messaging on interface 45 will now be described in more detail. Conventionally, COPS sends information on a per-flow basis. A requested service between endpoints 10, 20 may comprise several related flows of traffic. As an example, a video conferencing service will include conversational voice, real-time video and data representing slides to be discussed during the conference. As part of a connection establishment process, Application Manager 40 receives parameters of the requested service, the capabilities of the endpoints 10, 20, and determines what bandwidth is required. Application Manager 40 individually issues requests for each of the required flows, even if they are related to one another as part of a common service. Each request includes information about the required bandwidth, QoS and Class of service. The required bandwidth is determined by finding the codecs available at each endpoint 10, 20 and choosing a preferred combination (often, but not necessarily, a codec common to both endpoints 10, 20 which offers the best quality (greatest bandwidth)). Once the codec has been selected, this is translated into a required bandwidth which is used in the request. To give several examples, a G.711 codec with a packetisation rate of 10 ms over an IP transmission network has a bandwidth requirement of 102 kbps whereas a G.729 codec with the same 10 ms packetisation rate over an IP transmission network has a bandwidth requirement of 46 kbps.

Policy Server 50 verifies each request against network policies, determines whether network resources are available to meet the request and replies to the Application Manager 40 with an acknowledgement message.

In accordance with an embodiment of the invention, the Application Manager 40 issues a request across interface 45 which includes information for the group of related flows. This can be carried by a modified form of COPS messaging. This allows the Policy Server to consider all of the related flows (e.g. voice, video and data) at the same time, and to request/reserve network resources based on the combination of flows. In addition, the Application Manager 40 does not select the preferred codec itself, but passes a list of supported codecs to the Policy Sever 50. The list of codecs can be a list of codecs which is common to both endpoints (i.e. the AS looks at the codecs supported by both endpoints and only sends these), or it can be the list of codecs supported by each endpoint.

The Policy Server 40 inspects the codec information and submits a request for resources based on a particular policy.

As the Policy Server 50 interacts with the network entities responsible for reserving bandwidth, it is better placed to make a decision on what bandwidth can be supported by the network and hence what codecs can be used. If the network 30 can support the group of flows, the Policy Server 50 returns an acknowledgement message to the Application Manager 40. The acknowledgement includes a codec, selected by the Policy Server 50, which is appropriate for the bandwidth reserved on network 30. If there is more than flow, then the acknowledgement includes a selected codec for each flow. By considering a set of related flows together, and knowing the candidate codecs for each flow, the Policy Server 50 can adjust the resource reservation by choosing appropriate codecs for each flow. This is more efficient than repeated signalling exchanges between the Application Manager 40 and Policy Server 50 across interface 45 which specify single bandwidth values on a per-flow basis.

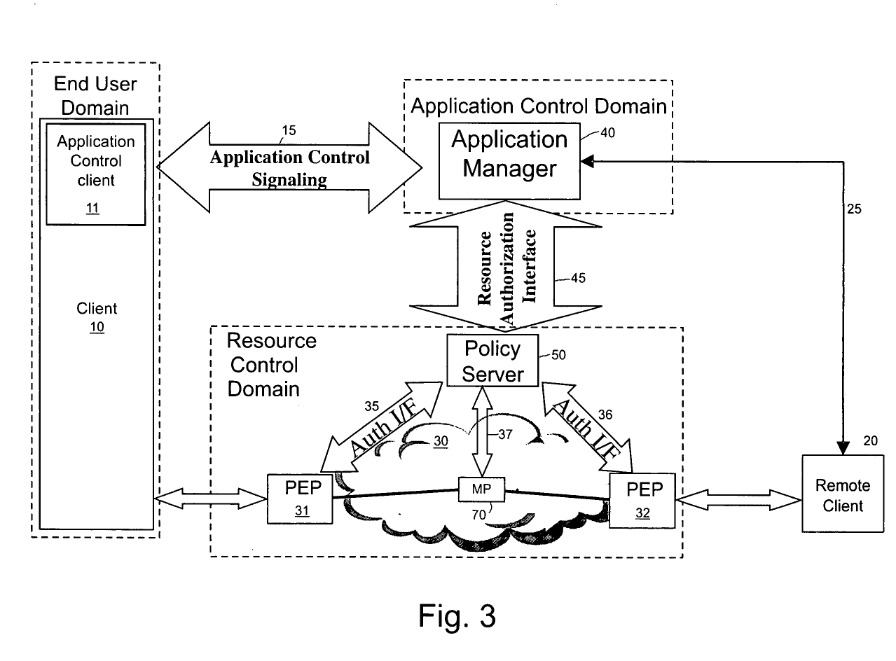

In accordance with an embodiment of the invention, the Policy Server 50 also takes part in Media Proxy control. FIG. 3 shows a similar network to FIG. 1, with the addition of a Media Proxy 70 within network 30. As part of the connection establishment process, Application Manager 40 sends the address and port(s) of the endpoints 10, 20 of the requested connection to the Policy Server 50. Policy Server 50 selects a suitable media proxy 35 for the requested flow(s) and passes an address and port of the media proxy 70 that should be used by the endpoints 10, 20. The reason for doing this is because the Policy Server 50 has a view of the network which the application server does not, so it can select the optimal media proxy based on available resources (e.g. bandwidth).

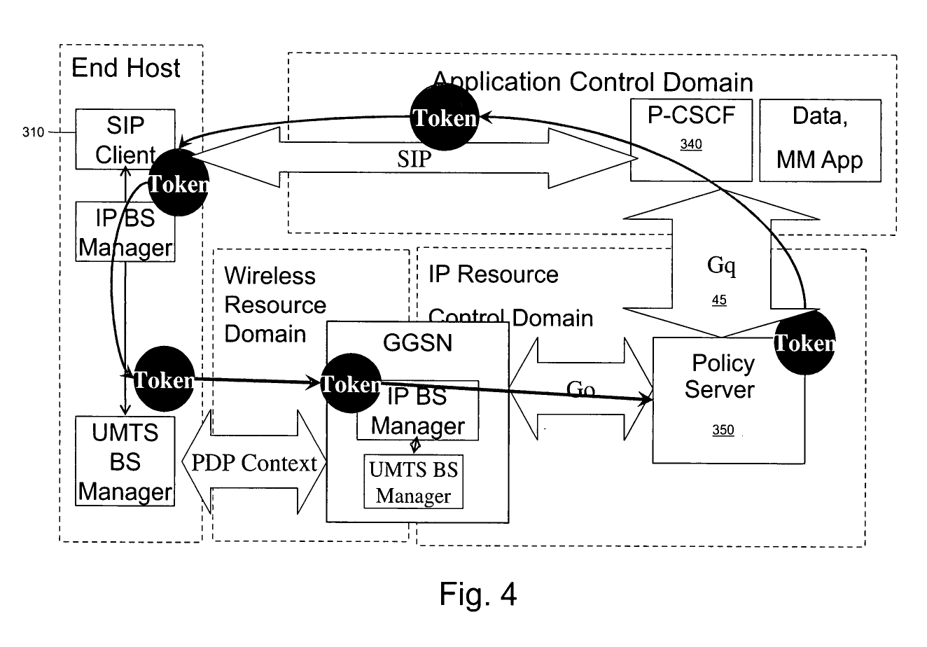

The above description refers to COPS. Standards bodies in other areas have considered other kinds of protocol for the interface 45 between the Application Manager 40 and Policy Server 50. FIG. 4 shows a Third Generation (3G) wireless network. An endpoint is represented by a Session Initiation Protocol (SIP) client 310. The Application Manager 40 is represented by a Proxy Call Session Control Function (P-CSCF) 340 which performs a similar function of authenticating a user's requests for services. The interface between the P-CSCF 340 and Policy Server 50 is called the Gq interface. Further information about the Gq interface can be found in the documents: 3^{rd} Generation Partnership Project; Technical Specification Group Services and System Aspects; End-to-end Quality of Service (QoS) concept and architecture (3GPP TS 23.207) and 3^{rd} Generation Partnership Project; Technical Specification Group Core Network; Policy control over Gq interface (3GPP TS 29.209). The 3GPP intend to use the Diameter protocol for the Gq interface, having considered the protocols SOAP/XML, COPS and Parlay. In the same manner as described above for COPS, the Diameter protocol similarly lacks support for passing call control information such as codec types between the Application Manager 40 and Policy Server 50.

In a further alternative of the invention, a Session Initiation Protocol (SIP) invite message is sent between the Application Manager 40 and the Policy Server 50 to pass application (call) control to the Policy Server. SIP messages carry application control related information to the Policy Server 50, which the Policy Server 50 can use to make selections of application control parameters.

The invention is not limited to the embodiments described herein, which may be modified or varied without departing from the scope of the invention.

We claim:

1. A method of establishing a connection between first and second endpoints in a packet-based communication system which comprises an application manager and a policy server, the method comprising, at the application manager:
receiving information about the required connection;
sending, to the policy server, application control related information for the required connection;
receiving, from the policy server, at least one application control parameter selected by the policy server.

2. A method according to claim 1 wherein the application control related information sent to the policy server comprises the set of codecs supported by the first and second endpoints and the application control parameter received from the policy server comprises a selected codec to be used by the endpoints.

3. A method according to claim 2 wherein the connection between endpoints comprises a plurality of related flows, the application control related information comprises information for each of the plurality of flows.

4. A method according to claim 3 wherein the application control parameter received from the policy server is based on the plurality of flows.

5. A method according to claim 1 wherein the application control related information sent to the policy server includes address/port information.

6. A method according to claim 5 wherein the application control parameter received from the policy server includes media proxy information based on the supplied address/port information.

7. A method according to claim 1 wherein the system further comprises at least one policy enforcement point (PEP) and the application control parameter received from the policy server is based on an interaction between the policy server and at least one PEP.

8. A method according to claim 1 wherein the application control related information further comprises at least one of: required bandwidth, QoS and class of service.

9. A method according to claim 1 wherein the application control information is sent using Session Initiation Protocol (SIP).

10. A method according to claim 1 wherein the application control information is sent using a modified form of one of: Common Open Policy Service (COPS), Diameter, SOAP/XML and Parlay.

11. A method according to claim 1 wherein the application control parameter is received using a modified form of one of: Common Open Policy Service (COPS), Diameter, SOAP/XML and Parlay.

12. A method of establishing a connection between first and second endpoints in a packet-based communication system which comprises an application manager and a policy control function, the method comprising, at the policy server:
receiving application control related information for the required connection from the application manager;
selecting at least one application control parameter for the required connection; and,
sending, to the application manager, the selected application control parameter.

13. A method according to claim 12 wherein the application control related information received from the application manager comprises the set of codecs supported by the first and second endpoints and the selected application control parameter comprises a selected codec to be used by the endpoints.

14. A method according to claim 13 wherein the connection between endpoints comprises a plurality of related flows, the application control related information comprises information for each of the plurality of flows.

15. A method according to claim 14 wherein the selected application control parameter is based on the plurality of flows.

16. A method according to claim 12 wherein the application control related information received from the application manager includes address/port information.

17. A method according to claim 16 wherein the selected application control parameter includes media proxy information based on the supplied address/port information.

18. A method according to claim 12 wherein the system further comprises at least one policy enforcement point (PEP) and the selected application control parameter is based on an interaction between the policy server and at least one PEP.

19. A method according to claim 12 wherein the application control related information further comprises at least one of: required bandwidth, QoS and class of service.

20. A method according to claim 12 wherein the application control parameter is sent using Session Initiation Protocol (SIP).

21. A method according to claim 12 wherein the application control information is received using a modified form of one of: Common Open Policy Service (COPS), Diameter, SOAP/XML and Parlay.

22. A method according to claim 12 wherein the application control parameter is sent using a modified form of one of: Common Open Policy Service (COPS), Diameter, SOAP/XML and Parlay.

23. An application manager for use as part of a packet-based communication system which comprises first and second endpoints and a policy server, the application manager being operable to:
receive information about a required connection between the first and second endpoints;
send, to the policy server, application control related information for the required connection;
receive, from the policy server, at least one application control parameter selected by the policy server.

24. A policy server for use as part of a packet-based communication system which comprises first and second endpoints and an application manager, the policy server being operable to:
receive application control related information for a required connection between the first and second endpoints from the application manager;
select at least one application control parameter for the required connection; and, send, to the application manager, the selected application control parameter.

25. A computer program product comprising instructions for causing a control entity of an application manager in a packet-based communication system which comprises first and second endpoints and a policy server to:
receive information about a required connection between the first and second endpoints;
send, to the policy server, application control related information for the required connection;
receive, from the policy server, at least one application control parameter selected by the policy server.

26. A computer program product comprising instructions for causing a control entity of a policy server in a packet-based communication system which comprises first and second endpoints and an application manager to:
receive application control related information for a required connection between the first and second endpoints from the application manager;
select at least one application control parameter for the required connection; and, send, to the application manager, the selected application control parameter.

27. A signal for use within a packet-based communication system comprising first and second endpoints, the signal having a format complying with a policy control protocol, the signal further carrying application control related information about a required connection between the first and second endpoints of the system.

28. A signal according to claim 27 wherein the connection between the first and second endpoints comprises a plurality of related flows, and the application control related information comprises information for each of the plurality of flows.

29. A signal according to claim 27 wherein the policy control protocol is one of: Common Open Policy Service (COPS), Diameter, SOAP/XML and Parlay.

30. A signal for use within a packet-based communication system comprising first and second endpoints, the signal having a format complying with a policy control protocol, the signal further carrying at least one application control parameter for a required connection between the first and second endpoints of the system.

31. A signal according to claim 30 wherein the policy control protocol is one of: Common Open Policy Service (COPS), Diameter, SOAP/XML and Parlay.
